(19) United States
(12) Patent Application Publication
(10) Pub. No.: US 2003/0233387 A1
(43) Pub. Date: Dec. 18, 2003

(54) Work-process status monitoring system, recording medium therefor, and work-process status monitoring and display apparatus

(76) Inventors: Norito Watanabe, Hitachi (JP); Ichiro Harashima, Hitachiota (JP); Yasuo Yoshinari, Kashiwa (JP); Hiroyuki Yuchi, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/463,692

(22) Filed: Jun. 18, 2003

(30) Foreign Application Priority Data
Jun. 18, 2002 (JP) 2002-177684

(51) Int. Cl. G06F 9/00

(52) U.S. Cl. 709/100

(57) ABSTRACT

A work-process status monitoring system for a task that is divided into multiple work processes that are shared enables the status of progress of each work process and the results of data transfer between the individual work processes to be grasped intuitively. The system comprises means for measuring the amount of work remaining in each work process, means for storing the measured amounts together with the measured time, and means for displaying the measured amounts of remaining work in each work process by way of chronological graphs separately or simultaneously.

### BACKGROUND OF THE INVENTION

1. Technical Field

The present invention relates to a technique for monitoring and confirming the status of progress of each of multiple work processes that make up a project or task.

2. Background Art

A project or task is often divided into a plurality of work processes, which are then simultaneously carried out. In such cases, merely managing the product in the final stage of the project, for example, cannot ensure that appropriate actions can be taken against a possible work delay in any of the work processes, or that measures can be taken to improve work efficiency. Consequently, the project may not be completed in time, or the budget may be exceeded. To avoid such consequences, it is necessary to monitor and grasp the status of progress of individual work processes of a project or the like that are carried out simultaneously.

In recent years, various project management software programs have been developed and available. Using these programs, one can designate a specific number of days required to complete each work item or a deadline. They provide a progress schedule, for example, which shows the percentage of completion of the entire task on a daily or hourly basis. JP Patent Publication (Kokai) Nos. 2001-134675 A1 and 11-320345 A1 (1999) disclose methods whereby the overall flow of work is diagrammatically shown such that the status of work in each process can be known. In the former (2001-134675), the colors of task blocks are changed depending on the status of input information reaching each task block. In the latter (11-320345), the amount of task that remains unfinished in each process is displayed by way of a graph.

In the conventional examples, the overall flow of work and the status of progress or delay can be grasped. However, these flow of work and the status that are indicated relate to a static state at the point of time of observation. For example, when a certain task is to be initiated, it may be sometimes more efficient to carry out the task all at once if the nature of the task is such that it takes a considerable time setting up or making preparations. In that case, just because a long time is being spent on the setting-up or preparation step does not mean that there is a problem from an overall point of view. Accordingly, in such a case, even if the techniques disclosed in the above-cited publications allows the overall flow of work or the status of progress or delay to be grasped, they cannot distinguish between a task that is really delayed and a task that is only apparently delayed.

Further, neither JP Patent Publication (Kokai) Nos. 2001-134675 A1 nor 11-320345 A1 (1999) disclose means for recognizing items of task that have been set aside for a long time or means for confirming the quality of an ongoing task. Thus, they cannot determine whether or not a present degree of completion of a deadline is being met, as the task progress from one step to another. Specifically, the above-mentioned prior art, which monitors the overall flow of work and/or the status of progress with reference to a progress chart, does not allow the quality of the finished product to be controlled. Thus, the above-mentioned prior art examples have the disadvantage that, although they can indicate the amount of remaining work in each work process, they cannot confirm the quality (degree of completion) of the task.

Furthermore, in the case of a project consisting of multiple work processes that are carried out simultaneously, the work efficiency of the individual work processes need to be made uniform if they are to flow smoothly. However, while the above-mentioned prior art examples allow the overall flow of work or the status of progress to be known by the progress schedule, they do not allow the work efficiency of each work process to be confirmed.

### SUMMARY OF THE INVENTION

It is an object of the invention to provide a work-process status monitoring system which allows the status of progress of individual work processes making up a project or task and the history of data transfer between individual work processes to be grasped intuitively.

In one aspect, the invention provides a system for monitoring the status of activity of a task that is divided into a plurality of work processes that are shared and carried out in parallel, the system comprising:

a first means for measuring the amount of remaining work in each of the multiple work processes;

a second means for storing the amount of remaining work in each of the work processes that is measured by the first means, together with the time of measurement; and

a third means for displaying the amounts of remaining work measured for the individual work processes by way of chronological graphs separately or simultaneously.

Thus, when a task is divided into multiple work processes that are shared, the status of progress of individual work processes and the results of data transfer between individual work processes can be grasped intuitively. It can also be recognized how a work process is being delayed along the time axis. By looking at the graphs, estimates can be made concerning future work progress based on the past results. Furthermore, by displaying chronological graphs of multiple work processes simultaneously the status of synchronization of the multiple work processes can be confirmed.

The work process status monitoring system may further comprise:

a fourth means for measuring .the quality of each item of remaining work of which the amount has been measured by the second means for each work process; and

a fifth means for displaying the quality of each item of remaining work measured by the fourth means for each work process, in the graphs of the amount of remaining work measured for each work process that are displayed by the third means.

Thus, when a task is divided into multiple work processes that are shared, the status of progress of individual work processes and the results of data transfer between the individual work processes can be grasped intuitively. Thus, chronological chances in the quality of remaining work can be intuitively grasped.

The quality of each item of remaining work measured by the fourth means for each work process may be either the number of days that has passed since a particular item of work was registered in a relevant work process, or the number of days until the deadline of the relevant work process, wherein the manner of display (such as by the color of display or hatching patterns) is varied depending on the number of days.

Thus, when a task is divided into multiple work processes that are shared, the status of progress of individual work processes and the result of data transmission between individual work processes can be intuitively grasped. By displaying the number of days that have passed, the status of work that has been remaining for a long time can be confirmed. By displaying the number of days until a deadline, an item of work or a work process that is likely to be behind schedule can be grasped.

The quality of each item of remaining work measured by the fourth means for each work process may. be the ratio of completion of a relevant work process, wherein the manner of display (such as by the color of display or hatching patterns) is varied depending on the ratio of completion.

Thus, when a task is divided into multiple work processes that are shared, the status of progress of individual work processes and the result of data transmission between individual work processes can be intuitively rasped. By displaying the ratio of work that has been completed, estimates can be made as to when a piece of work can be passed onto the next work process.

In another aspect, the invention provides a system for monitoring the status of activity of a task that is divided into a plurality of work processes that are shared and carried out in parallel, the system comprising:

a fifth means for measuring the amounts of transition of work between the individual work processes;

a sixth means for storing the amounts of transition of work between individual work processes measured by the fifth means, together with the time of measurement; and

a seventh means for simultaneously displaying the amounts of transition of work between individual work processes which are stored by the sixth means for each of the multiple work processes, in chronological graphs.

Thus, when a task is divided into multiple work processes that are shared, the status of progress of individual work processes and the result of data transmission between individual work processes pan be intuitively grasped. Further, relative work efficiency of each work process can be grasped from an overall point of view.

In another aspect, the invention provides a system for monitoring the status of activity of a task that is divided into a plurality of work processes that are shared and carried out in parallel, the system comprising:

a fifth means for measuring the amount of transition of work between the individual work processes;

a sixth means for storing the amount of transition of work between the individual work processes measured by the fifth means, together with the time of measurement: and

an eighth means for simultaneously displaying the accumulation of the transition amount of work between the individual work processes, which are stored by the sixth means for each work process, in chronological graphs.

Thus, when a task is divided into multiple work processes that are shared, the status of progress of individual work processes and the result of data transmission between individual work processes can be intuitively grasped.

The work-process status monitoring system may further comprise a ninth means for displaying each work process with a box-shaped icon, the connection of one work process to another with an arrow-shaped icon, and a valve-shaped icon in the middle of the arrow-shaped icon, wherein a graph of remaining work amounts is displayed upon selection of the box-shaped icon, and another graph of the amounts of transition of work between individual work processes is displayed upon selection of the valve-shaped icon.

Thus, when a task is divided into multiple work processes that are shared. the status of progress of individual work processes and the result of data transmission between individual work processes can be intuitively grasped. Further, the work processes as they are performed in a flow of work, the flow of work. and the control of the flow can be more intuitively grasped by describing them using metaphors of tanks, pipes, and valves that are typically used in piping and instrumentation drawings in the design of piping, for example.

The manner in which the valve-shaped icon, which is disposed in the middle of the arrow-shaped icon indicated of the ninth means, is displayed may be varied depending on the content of work that is passed from one box-shaped icon to another via the valve-shaped icon if the content of work matches a preset work monitoring content, whereas a warning message may be issued if the content of work does not match a preset work monitoring content.

Thus, when a task is divided into multiple work processes that are shared, the status of progress of individual work processes and the result of data transmission between individual work processes can be intuitively grasped. Further the work processes as they are performed in a flow of work, the flow or work and the control of the flow can be intuitively grasped by describing them using metaphors of tanks, pipes, and valves that are typically used in piping and instrumentation drawings in the design of piping, for example.

The preset content of work that is monitored may be the deadline or quality of a task.

Thus, when a task is divided into multiple work processes that are shared, the status of progress of individual work processes and the result of data transmission between individual work processes can be intuitively grasped.

In another aspect, the invention provides a recording medium in which a software program is stored for analyzing a task using the above-described work-process status monitoring system.

Thus, when a task is divided into multiple work processes that are shared, the status of progress of individual work processes and the result of data transmission between individual work processes can be intuitively grasped.

In yet another aspect, the invention provides a display apparatus for monitoring the status of activity of a task that is divided into a plurality of work processes that are shared and carried out in parallel, the apparatus comprising:

means for measuring the amount of remaining work in each of the multiple work processes;

means for storing the amount of remaining work in each of the work processes that is measured by the remaining work amount measuring means, together with the time of measurement; and

means for displaying the amounts of remaining work measured for the individual work processes by way of chronological graphs separately, or simultaneously.

Thus, when a task is divided into multiple work processes that are shared, the status of progress of individual work processes and the results of data transfer between individual work processes can be grasped intuitively. It can also be recognized how a work process is being delayed along the time axis. By looking at the graphs, estimates can be made concerning future work progress based on the past results. Furthermore, the status of synchronization of the multiple work processes can be confirmed based on the simultaneous display of chronological graphs for multiple work processes.

The work-process status monitoring and display apparatus may further comprise:

means for measuring the quality of each item of remaining work of which the amount has been measured by the work-work amount measuring means for each work process; and

means for displaying the quality of each item of remaining work measured by the work-work quality measuring means for each work process, in the graphs of the amount of remaining work measured for each work process that are displayed by the remaining-work amount display means.

Thus, when a task is divided into multiple work processes that are shared, the status of progress of individual work processes and the results of data transfer between the individual work processes can be grasped intuitively. Thus chronological changes in the quality of remaining work can be intuitively grasped.

The quality of each item of remaining work measured by the remaining-work quality measuring means for each work process may be either the number of days that have passes since a particular item of work has registered in a relevant work process, or the number of days until the deadline of a relevant work process, wherein the manner of display (such as by the color of display or hatching patterns) is varied depending on the number of days.

Thus, when a task is divided into multiple work processes that are shared, the status of progress of individual work processes and the result of data transmission between individual work processes can be intuitively grasped. By displaying the number of days that have passed, the status of work that has been remaining for a long time can be confirmed. By displaying the number of days until a deadline, an item of work or a work process that is likely to be behind schedule can be grasped.

The quality of each item of remaining work measured by the remaining work quality measuring means for each work process may be the ratio of completion of a relevant work process, wherein the manner of display (such as by the color of display or hatching patterns) is varied depending on the ratio of completion.

Thus, when a task is divided into multiple. work processes that are shared, the status of progress of individual work processes and the result of data transmission between individual work processes can be intuitively grasped. By displaying the ratio of work that has been completed, estimates can be made as to when a piece of work can be passed onto the next work process.

In yet another aspect, the invention provides a display apparatus for monitoring the status of activity of a task that is divided into a plurality of work processes that are shared and carried out in parallel, the apparatus comprising:

means for measuring the amount of transition of work between the individual work processes;

means for storing the amount of transition of work between the individual work processes measured by the transitioned work amount measuring means, together with the time of measurement; and

means for simultaneously displaying the amounts of transition of work between individual work process, which are measured by the transitioned work amount measuring means for each of the multiple work processes, in chronological graphs.

Thus, when a task is divided into multiple work processes that are shared, the status of progress of individual work processes and the result of data transmission between individual work processes can be intuitively grasped. Further, relative work efficiency of each work process can be grasped from an overall point of view.

In a further aspect, the invention provides a display apparatus for monitoring the status of activity of a task that is divided into a plurality of work processes that are shared and carried out in pararel, the. apparatus comprising:

means for measuring the amount of transition of work between the individual work processes;

means for storing the amount of transition of work between the individual work processes measured by the transitioned work amount measuring means, together with the time of measurement; and

means for simultaneously displaying the accumulation of the transition amount of work between the individual work processes, which are measured by the transitioned work amount measuring means for each work process in chronological graphs.

Thus, when a task is divided into multiple work processes that are shared, the status of progress of individual work processes and the result of data transmission between individual work processes can be intuitively grasped.

The work-process status monitoring and display apparatus may further comprise a display means for displaying each work process with a box-shaped icon, the connection of one work process to another with an arrow-shaped icon, and a valve-shaped icon in the middle of the arrow-shaped icon, wherein a graph of remaining work amounts is displayed upon selection of the box-shaped icon, and another graph of the amounts of transition of work between individual work processes is displayed upon selection of the valve-shaped icon.

Thus, when a task is divided into multiple work processes that are shared, the status of progress of individual work processes and the result of data transmission between individual work processes can be intuitively grasped. Further, the work processes as they are performed in a flow of work, the flow of work and the control of the flow can be more intuitively grasped by describing them using metaphors of tanks, pipes, and valves that are typically used in piping and instrumentation drawings in the design of piping, for example.

The manner in which the valve-shaped icon, which is disposed in the middle of the arrow-shaped icon by the display means, is displayed may be varied depending on the content of work that is passed from one box-shaped icon to another via the valve-shaped icon if the content of work matches a preset work monitoring content, whereas a warning message is issued if the content of work does not match a preset work monitoring content.

Thus, when a task is divided into multiple work processes that are shared, the status of progress of individual work processes and the result of data transmission between individual work processes can be intuitively grasped. Further, the work processes as they are performed in a flow of work, the flow of work, and the control of the flow can be intuitively grasped by describing them using metaphors of tanks, pipes, and valves that are typically used in piping and instrumentation drawings in the design of piping, for example.

The preset content of work that is monitored may be the deadline or quality of a task.

Thus, when a task is divided into multiple work processes that are shared, the status of progress of individual work processes and the result of data transmission between individual work processes can be intuitively grasped.

### BRIEF DESCRIPTION OF THE DRAWINGS

FIG. 1 shows a work-process status monitoring system or a work-process status monitoring and display apparatus according to an embodiment of the invention.

FIG. 2 shows a progress management window displayed on the display device shown in FIG. 1.

FIG. 3 shows another example of the progress management window employing a piping and instrumentation chart.

FIG. 4 shows another example of the progress management window employing transition graphs indicating the amounts of remaining work.

FIG. 5 shows examples of the contents of data stored in a measurement result storage unit.

FIG. 6 shows a chronological graph display in which the relationships between work remaining amounts measured in the past are shown.

FIG. 7 shows a chronological graph display in which the relationships between work remaining amounts measured in the past are shown.

FIG. 8 shows a chronological graph display in which the relationships between work remaining amounts measured in the past are shown.

FIG. 9 shows another example of the display of remaining work amounts.

FIG. 10 shows another example of the display of remaining work amounts employing a quality-based graph.

FIG. 11 shows another example of the progress management window employing graphs indicating the transition of transferred data accumulations between individual work processes.

FIG. 12 shows another example of the progress management window employing graphs indicating the transition of data transfer throughput between individual work processes.

FIG. 13 shows another example of the progress management window in which the progress management statuses of individual process steps are displayed on a single window in a comparative manner.

FIG. 14 shows boxes representing individual work processes, each box containing a tank indicating the data passed down from an upstream process.

FIG. 15 shows boxes representing individual work processes, each box divided into an input region and an output region.

FIG. 16 shows an example of display of the contents of data that is monitored between individual work processes.

FIG. 17 shows an example of a system configuration when the activity status visualizing system for workflow control.

### DESCRIPTION OF THE INVENTION

Hereafter, the invention will be described by way of embodiments with reference mad to the drawings.

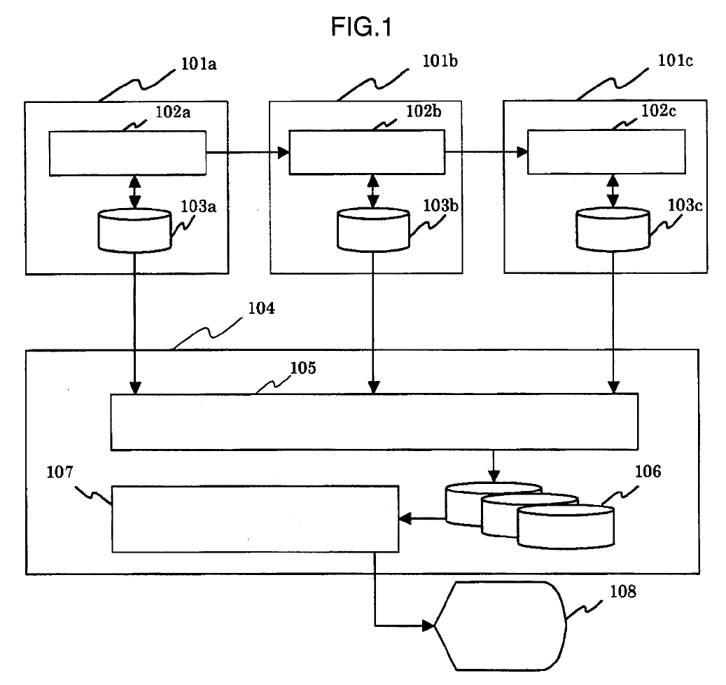

FIG. 1 shows a work-process status monitoring system or a work-process status monitoring and display apparatus according to an embodiment of the invention.

The present embodiment is based on the assumption that there are three work processes. Each work process employs a work tool 101a, 101b, or 101c including, for example, a personal computer or a workstation. Each work tool 101a, 101b, or 101c includes a work function 102a, 102b, or 102c and storage unit 103a, 103b, or 103c for storing data being worked on, respectively. An operator processes data on the work tool 101 (101a, 101b, 101c) in each work process, using the work function 102 (102a, 102b, 102c), and stores untouched or unfinished data in the storage unit 103 (103a, 103b, 103c). When the work is completed in one work process, the resultant data is sent to the work function 102 of the next process.

A progress status monitoring tool 104 includes a measurement unit 105, a measurement result storage unit 106 for storing the results of measurement, and a display processing unit 107 for processing the results for display. The processed results are displayed by a display unit 108.

The measurement unit 105 of the progress status monitoring tool 104 accesses the storage unit (103a, 103b, 103c) in the work tool (101a, 101b, 101c) at preset time intervals and measures the storage status of work-data. The measured results are stored in the measurement result storage unit 106.

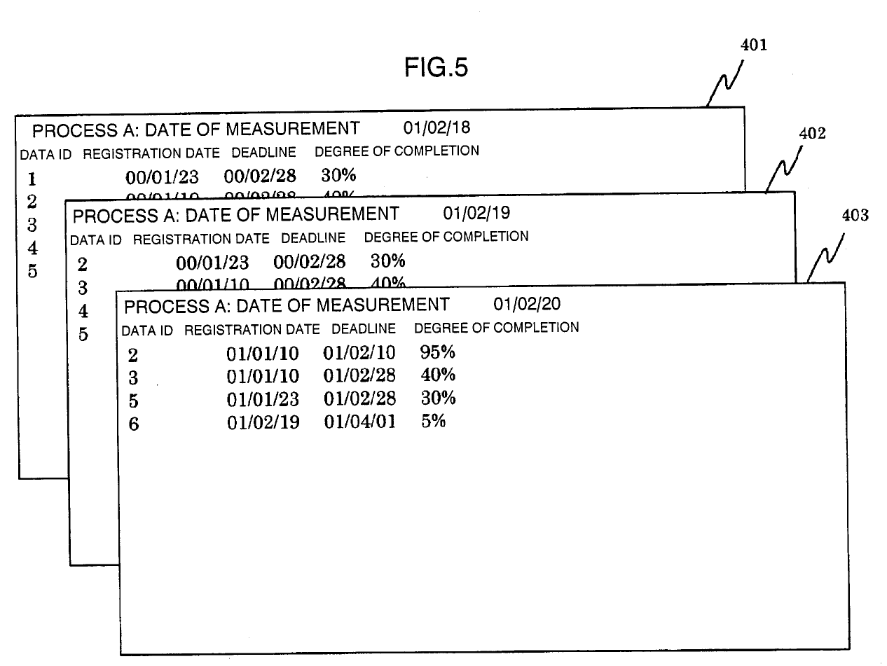

The data stored in the measurement result storage unit 106 is configured as shown in FIG. 5, for example. The data shown in FIG. 5 relates to a work process A and records the status of stored data in individual steps on a daily basis as data 401 data 402 and data 403. Information recorded in each of the data items 401, 402, and 403 includes the date or time of measurement, a work ID, the date of registration of data for each work ID in each step, the deadline of each step and the degree of completion of each step. The degree of completion in FIG. 5 concerns information indicating that percentage of the necessary information has been set in the case of a design work, for example. Such information can be obtained by measuring the number of data fields that have been set in all of the data fields, for example. The information can also be provided by the worker in charge of each step on a voluntary basis.

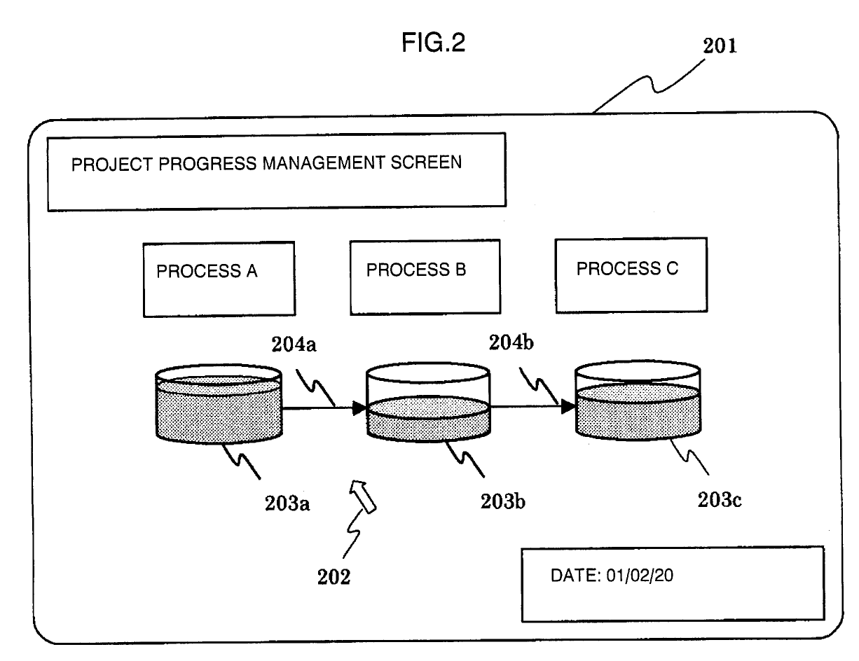

FIG. 2 shows an example of a window 201 displayed on the display unit 108 shown in FIG. 1. The window 201 shows a box- or tank-shaped FIGS. 203a, 203b, and 203C indicating the status of storage of remaining work (data storage status) in each work process. The box- or tank-shaped figures are connected by lines such as arrows 204a and 204b indicating the flow of work. A user of this work-process status monitoring system or work-process status monitoring and display apparatus can demand a display of detailed information about each process by selecting (clicking) the corresponding figure with a cursor 202, for example, on the display.

In the window 201 shown in FIG. 2, it is possible to vary the manner in which the box- or tank-shaped FIGS. 203a, 203b, and 203c are displayed depending on the amount of remaining work in each process. In the example of FIG. 2, the window 201 shows how the content of each tank varies depending on the amount of remaining work. The amount of remaining work in each process (processes A, B, and C) can be determined based on the data shown in FIG. 5, which is stored in the measurement result storage unit 106 shown in FIG. 1. In the example of FIG. 2, each tank is filled to a level corresponding to the number of remaining items of work in each process (processes A, B. and C).

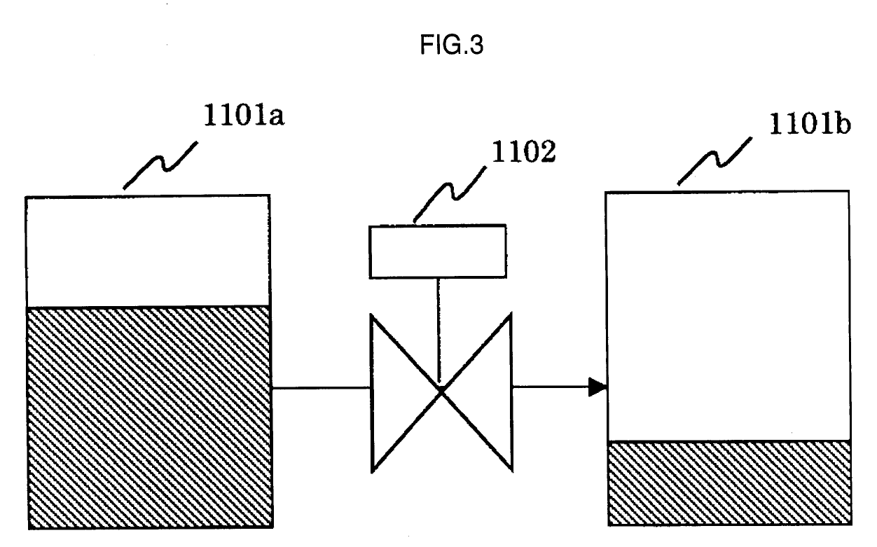

The display may be based on a piping and instrumentation chart that is conventionally used in describing piping design drawings, as shown in FIG. 3. In this figure, numerals 1101a and 1101b designate tanks representing each work process. The tanks 1101a and 1101b are connected by a line (arrow) indicating a pipe which is provided in the middle with a valve 1102. The valve 1102 can represent the measuring or controlling of the flow of work between the work processes. Measuring and control methods will be described later.

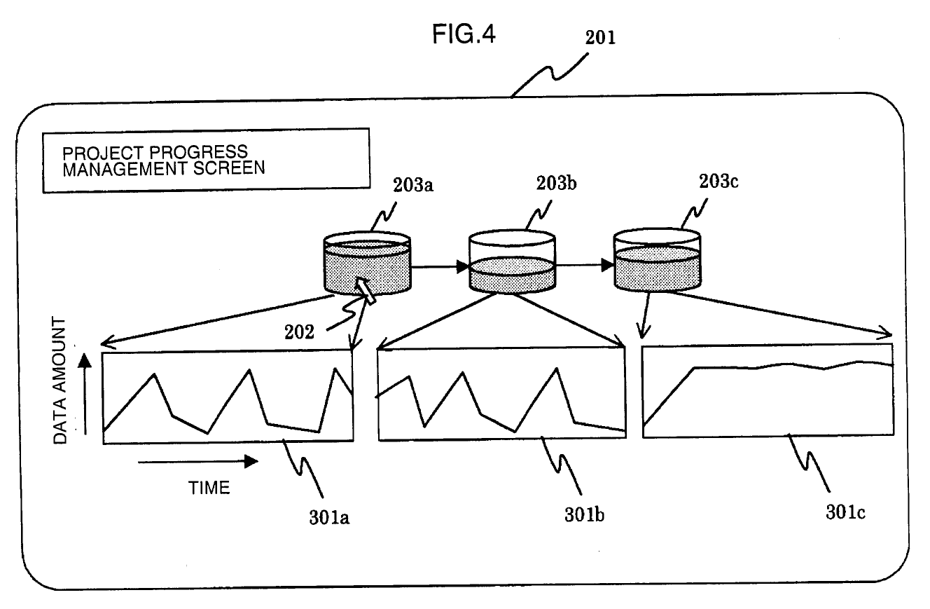

In the example of FIG. 2, the amounts of remaining work in the individual work processes at a designated date and/or time are indicated. They indicate static states, and do not reflect whether or not a particular piece of work is actually behind schedlle. This problem is solved by a display shown in FIG. 4.

FIG. 4 shows the result of selecting the individual tanks 203a, 203b, and 203c using the cursor 202 on the window 20 shown in FIG. 2 to demand a chronological graph display for each tank. Such a demand may be made by any of the conventional methods, such as, for example, selecting from a menu, such as a pop up menu or cricking a desired tank figure. The manner of making such a demand, therefore, will not be described herein in detail.

When a chronological graph display is selected, the display processing unit 107 shown in FIG. 1 creates graphs by referring the data in the measurement result storage unit 106 of FIG. 1, the graphs plotting the relative amounts of work remaining that have been recorded in the past measurement times. The results are shown in FIG. 4 as graphs 301a, 301b, and 301c. In FIG. 4, the tanks 203a, 203b, and 203 corresponding to the individual work processes are displayed in a row, below which the corresponding graphs 301a, 301b. and 301c are displayed in a row.

By looking at the chronological graphs 301a, 301b, and 301c shown in FIG. 4 indicating the relative amounts of remaining work measured in the past, one can grasp how each work process has progressed in the past. Based on these graphs, one can predict that a temporary accumulation of work at a specific point in time of measurement would disappear in time. Further as the graphs 301a, 301b and 301c are arranged side by side and indicate the relationship of the amounts of remaining work for the individual work processes simultaneously, one can grasp how the work processes are synchronized by comparing the graphs 301a, 301b and 301c.

In the example shown in FIG. 4, it can be seen that there is a relatively high level of synchronization between the process corresponding to the tank 203a and that to the tank 101b based on the relationship between the two graphs 301a and 301b. On the other hand, the process corresponding to the tank 203c is stagnant, based on the graph 301c.

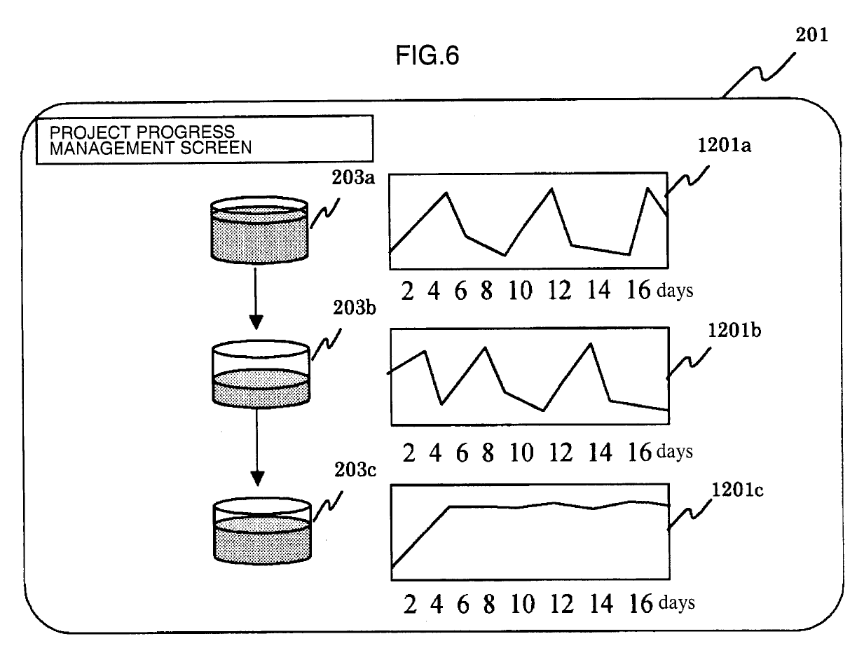

FIG. 6 shows another example of the chronological graph display of the relative amounts of work remaining that have been measured in the past. The graphs are created upon selecting a chronological graph display, based on the data in the measurement result storage unit 106 shown in FIG. 1. In this example, the tanks 203a, 203b, and 203c corresponding to each work process are arranged in a vertical column. Corresponding graphs 1201a, 1201b, and 1201c are arranged also in a vertical column beside the tanks 203a, 203b and 203c. This manner of display allows one to compare the chronological transitions of the remaining work amounts relative to one another.

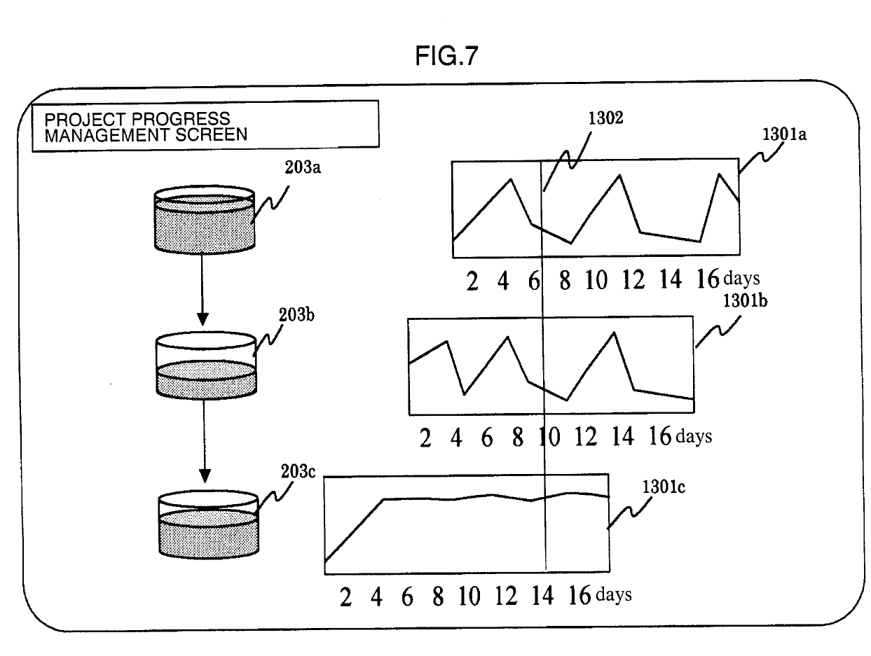

FIG. 7 shows yet another example of the chronological graph display of the relative amounts of work remaining that have been measured in the past. The graphs are created upon selecting a chronological graph display, based on the data in the measurement result storage unit 106 shown in FIG. 1. In this example, the tanks 203a, 203b, and 203c corresponding to each work processes are arranged in a vertical column. Corresponding graphs 1301a, 1301b, and 1301c are arranged also in a vertical column beside the corresponding tanks 203a, 203b, and 203c. In this example, the graphs are arranged in a staggered manner with reference to a time transition 1302 where individual patterns of the chronological changes in the remaining work amount are most closely matched to one another. In this way, relative delays in the flow of work among the individual work processes can be clearly indicated.

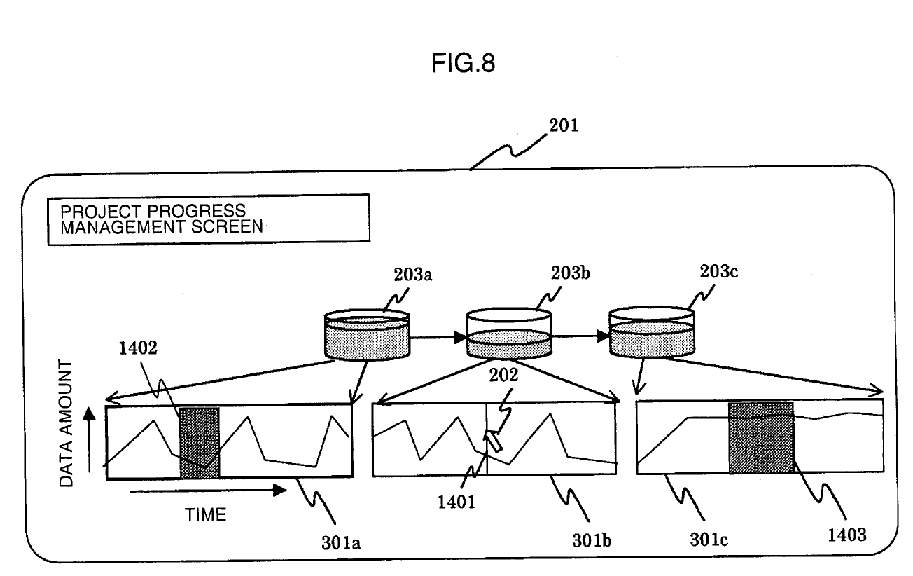

FIG. 8 shows yet another example of the chronological graph display of the relative amounts, of remaining work that have been measured in the past. The graphs are created upon selecting a chronological graph display, based on the data in the measurement result storage unit 106 shown in FIG. 1. In this example, the tanks 203a, 203b, and 203c corresponding to the individual work processes are arranged in a row, as in FIG. 4. Graphs 301a, 301b, and 301c are arranged horizontally below the corresponding tanks 203a, 203b. and 203c. In this example, a work process and a date/time are designated by a designation line 1401 which is produced by placing the cursor 202 on the graph 301b associated with the tank 203b for example. In the work process designated by the designating line 1401, an item of work that is remaining at the designated time is determined. Then the times when the particular remaining work was being processed in the upstream process (tank 203a) and the downstream process (tank 203c) are indicated by FIGS. 1402 and 1403, respectively, on the graphs 301a and 301c, respectively. Thus one can visually grasp, by way of the graphs 301a and 301c, how the work that remains at the time and in the work process designated with the designating line 1401 by the operation of the cursor 202 is being processed in the upstream step (tank 203a) and the downstream step (tank 203c).

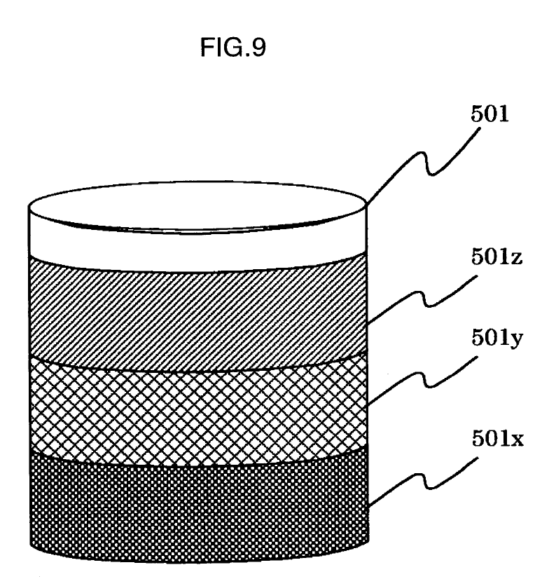

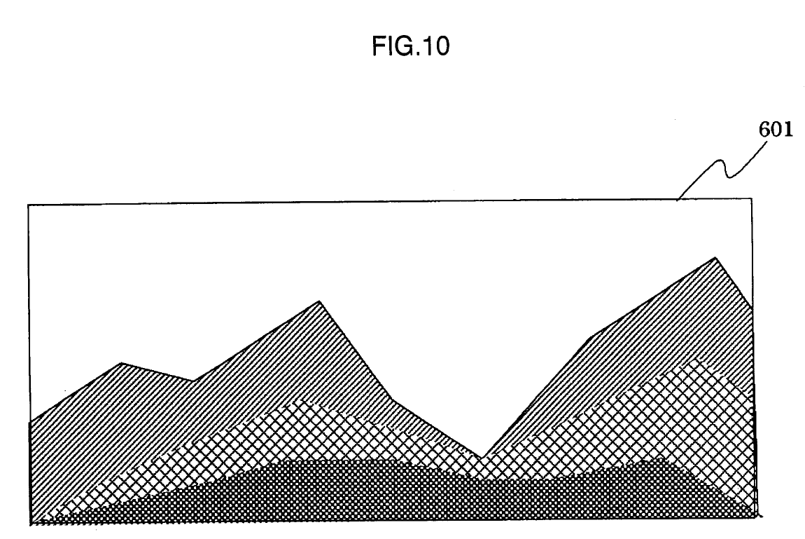

FIGS. 9 and 10 show other examples of the way the remaining work is displayed.

In the examples of FIGS. 9 and 10, the manner of display is varied depending on the quality of the remaining work. The quality of the remaining work can be evaluated based on the number of days a particular item of work has been remaining in the work process, the number of days remaining until the deadline of the process, or the degree of completion of the work. The number of days the work has been left unfinished can be determined by calculating the number of days that has passed since the particular work was registered on the work process. By assigning different colors 501x 501y and 501z to the display depending on the number of days that have passed, as shown in FIG. 9, one can grasp work items that are left unattended for a long time. For example, a work item that has been left unattended for a day or so since registration may be indicated in green, a work item that is about a week or so old may be indicated in yellow, and a work item that is more than a month old may be indicated in red, thus indicating the flow of work. Further, the individual remaining tasks may be displayed chronologically, as shown in a graph 601 shown in FIG. 10, such that one can recognize how the work items are being processed along the time axis taken along the horizontal axis.

The degree of completion of work can be determined based on the ratio of items filled in necessary data items, or the ratio of current data volume to the volume of data at completion, as described above. It can also be based on evaluation data supplied by individual workers in charge of each step on a voluntary basis.

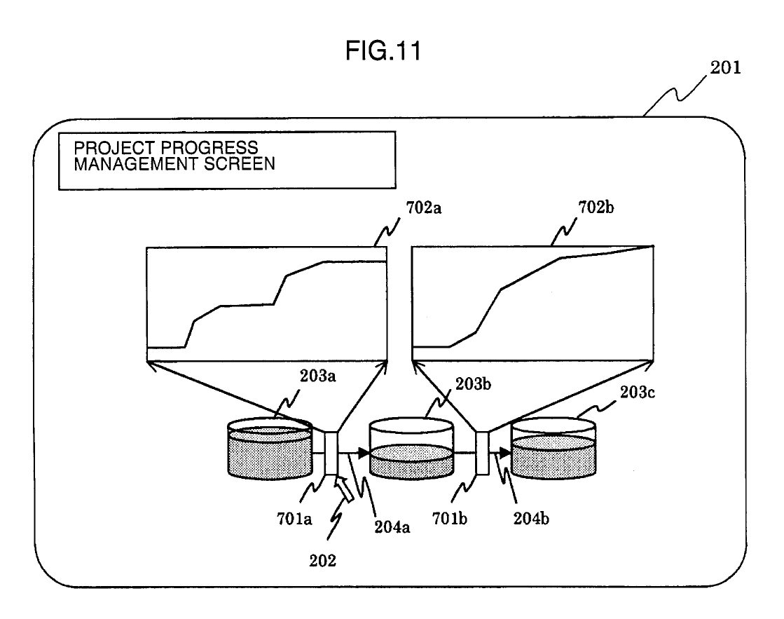

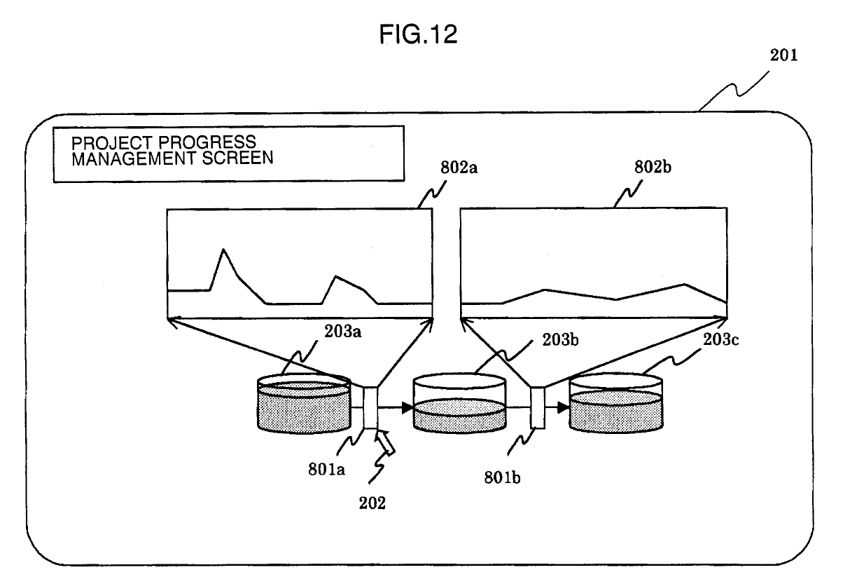

FIGS. 11 and 12 show another embodiment of the work process status monitoring system and the work-process status monitoring and display apparatus according to the invention.

In the example shown in FIG. 11, arrows 204a and 204b indicating the flow of work in a display window 201 are provided with selection FIGS. 701a and 701b. By selecting either of the selection FIGS. 701a and 701b with a cursor 202, a chronological graph 702a or 702b indicating the accumulated amount of work that has passed through each arrow can be displayed (visualized).

In the example of FIG. 12, selection figurers 801a and 801b are similarly provided. By selecting either of the FIGS. 801a and 801b with the cursor 202, chronological graph 802a or 802b indicating the throughput of work that has passed through each arrow can be displayed (visualized). The throughput herein refers to the amount of work that passes in a given. period of time, and it therefore corresponds to the slope of the accumulation amount graphs shown in FIG. 11.

By using the examples of FIGS. 11 or 12, the work efficiency of each work process can be grasped in an overall picture.

In the examples thus far described, there is a single flow of work. Generally, however, a piece of work is carried out based on data provided by a plurality of sections or departments, or the results of a single process may be utilized in a plurality of processes. Such cases can be dealt with by employing the manners of display as will be described by referring to Fis. 13 to 15

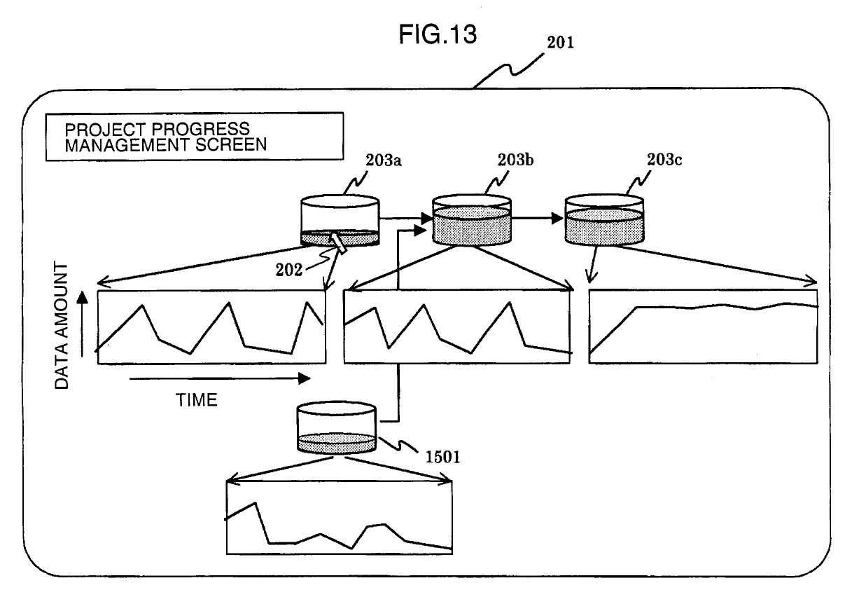

FIG. 13 illustrates the case where data flows from two work processes (tanks 203a and 1501 ) to a single work process (tank 203b). In this example, the tanks 203a and 1501 corresponding to individual work processes are each connected to the receiving tank, 203b by an arrow. By thus showing the individual processes in a comparative manner on a single window, one can clearly see the manner in which data flows.

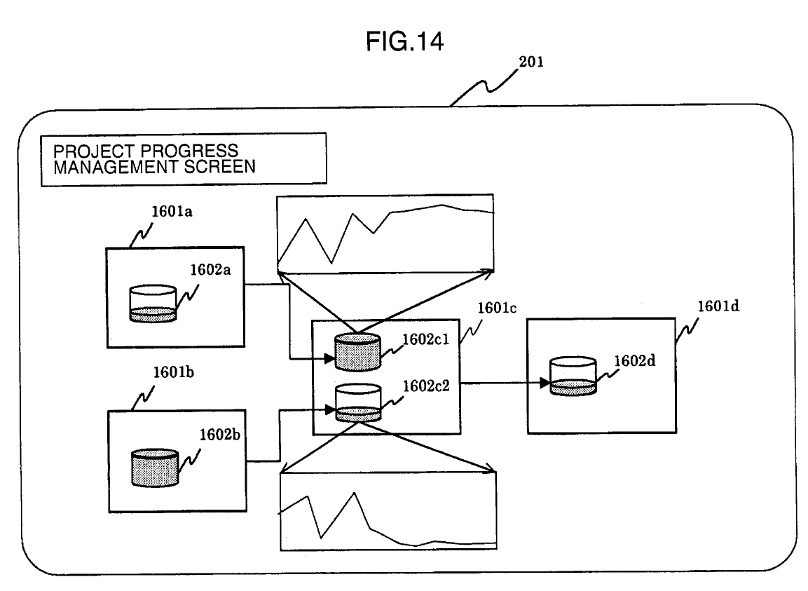

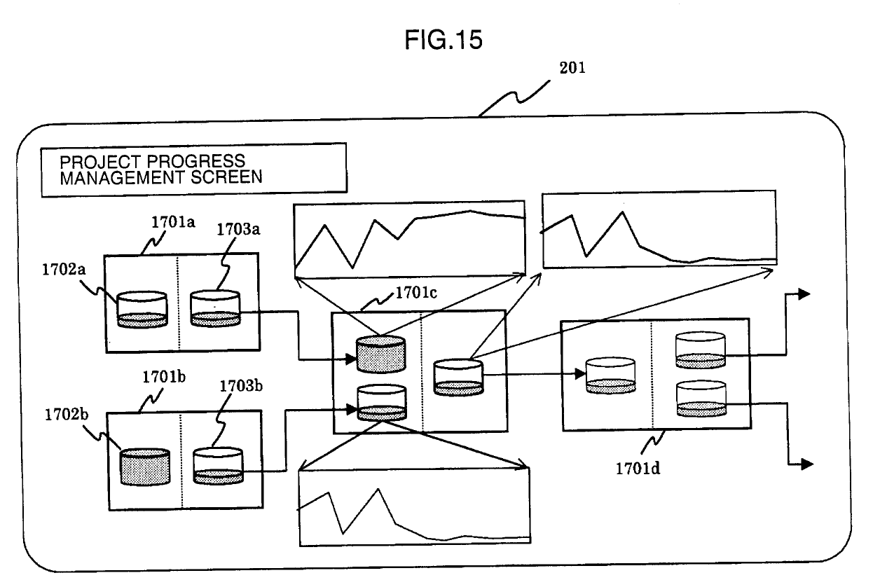

In the above-described embodiments, a piece of design data is processed on a shared basis in the upstream to downstream work processes. There are cases, however, when new data is created by referring to data that has been created in an upstream process and then passed clown to a downstream process. Such examples are shown in FIGS. 14 and 15.

FIG. 14 shows boxes 1601a, 1601b, 1601c, and 1601d representing individual work processes. The boxes contain tanks 1602a, 1602b, 1602c, and 1602d representing data passed down from upstream that is referred to in the middle of a process. By thus displaying the work processes and data, it can be clearly seen which upstream process or processes are being delayed.

In the example of FIG. 15, individual work processes are indicated by boxes 1701a, 1701b, 1701c, and 1701d. Each box is divided into an input region and an output region. In the input regions of the work process, the amount of data passed down from an upstream process is indicated by tank 1702a, 1702b, and so on. In the output regions of the work processes, the amount of data from an upstream process is indicated by tanks 1703a 1703b, . . . and so on. Thus, by displaying the input and output regions of each work process separately, the amount of work can be visualized even when different items of data are created in a particular process, such as in the box 1701d, for a plurality of downstream processes.

Hereafter, a workflow monitoring system will be described as another embodiment of the invention.

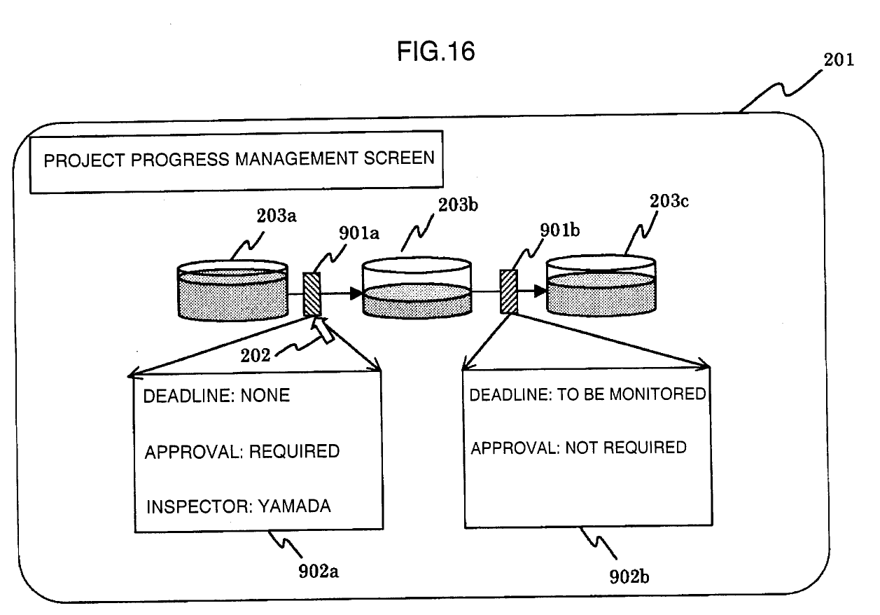

FIG. 16 shows a display window 201 for the workflow monitoring system.

The monitoring system shown in FIG. 16 monitors data as it is moved from one process to another. The monitoring system can be used in term administration and/or data quality management, for example. In the example of FIG. 16, each arrow that represents the flow of data has a FIG. 901a or 901b for designating attributes to be monitored. By selecting the FIG. 901a or 901b with a cursor 202, for example, detailed information can be displayed and/or modified. The detailed information is indicated on windows 902a and 902b.

The window 902a indicates that there is no need for term administration but quality management is required and that Mr. or Ms. Yamada's approval is required. The window 902b indicates that while approval is not required, term administration is to be carried out.

Specifically, when data is transferred from the work process in the tank 203a to that in the tank 203b, Mr. or Ms. Yamada's quality check and approval are required. When data is transferred from the work process corresponding to the tank 203b to that corresponding to the tank 203c only term administration is carried out.

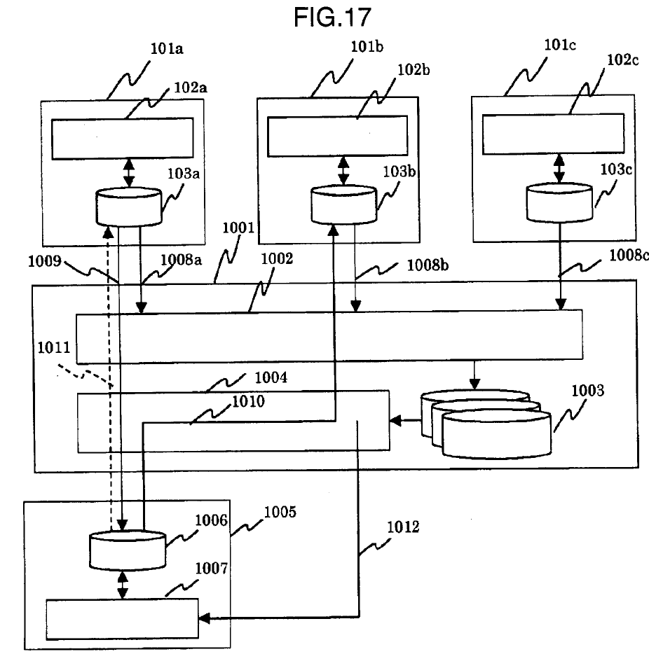

FIG. 17 shows a system configuration for the above-described workflow monitoring system.

This system configuration includes three work tools 101a, 101b, and 101c, which correspond to the similarly referenced work tools shown in FIG. 1. The system also includes data storage units 103a, 103b, and 103C, which also correspond to similarly referenced data storage units shown in FIG. 1. The work tools 101a, 101b and 101c include work functions 102a 102b and 102c respectively, and storage units 103a, 103b, and 103c, respectively. Each of the storage units stores data that is being processed by the corresponding work function 102a, 102b, or 102c.

A progress status monitoring tool 1001 shown in FIG. 17 monitors the data in the data storage units 103a, 103b, and 103c in the individual work tools 101a, 101b, and 101c, to monitor the progress of work and controls the flow of data. The progress status monitoring tool 1001 is comprised of a measurement unit 1002, a measurement result storage unit 1003 and a flow control unit 1004. The measurement unit 1002 accesses the data storage unit (103a, 103b, 103c) included in the work tool (101a, 101b, 101c) at preset time intervals and measures the state of storage of work data (1008a, 1008b, 1008c). The measured results are stored in the measurement result storage unit 1003. The flow control unit 1004 transfers the data in the data storage unit (103a, 103b, 103c) in each work tool (101a, 101b, 101c) to an approval process, or controls the generation of warning events for example by referring to the data in the measurement result storage unit 1003.

When the flow is defined as shown in FIG. 16, the flow control unit 1004 shown in FIG. 17 operates as follows.

A worker operating with the work tool 101a shown in FIG. 17 declares the end of a certain work item upon completion of the corresponding work process. The declaration is detected by the measurement unit 1002, and registers the end of the work item in the measurement result storage unit 1003. The end of the work item is then recognized by the flow control unit 1004, which monitors the measurement result storage unit 1003.

Further the flow control unit 1004 recognizes the information concerning the transition of data from the work tool 101a to the work tool 101b based on the content of the instruction window 902a shown in FIG. 16, and determines that the particular work item requires inspection. The flow control unit 1004 then transfers the data outputted from the data storage unit 103a in the work tool 101a, the data having been recognized from the content indicated on the instruction window 902a as shown in FIG. 16, to a for-approved data storage unit 1006 in an approval tool 1005 used by an inspector (1009).

The inspector, using an inspection function 1007 of the approval tool 1005, accesses the for-approved data storage unit 1006, inspects the quality of data, and determines whether or not approval should be given. If approved in the approval tool 1005, the data as recognized from the contents in the instruction window 902a of FIG. 16 is fed to the flow control unit 1004. The flow control unit 1004 then transfers the data to the next work process tool 101b (1010). If the data is not approved in the approval tool 1005, the data is returned to the work tool 101a (1011).

The data that is transferred from the work tool 101b to the work tool 101c only concerns term administration, as shown in the window 201 of FIG. 16 which is the window shown on the display device 108 of FIG. 1. The flow control unit 1004 then refers to the data stored in the measurement result storage unit 1003. If the stored data has passed the deadline or is likely to pass the deadline, the flow control unit 1004 issues a warning event 1012 to the tool 1005 of the person who is managing the progress status of the particular process.

By thus managing the transition of data between the individual work processes, the workflow can be controlled.

Hereafter, concrete examples of the tasks whose status can be managed by the above-described system will be described.

First, a case will be considered where the system is applied to the designing of a chemical or a power-generating plant. In this case, the task can be divided into a primary design step, a detailed design step, and a material arrangement step, for example. In each step, a plurality of items of work are simultaneously carried out in parallel. In each step, there are even more subdivided task-flows, such as, for example, decision concerning specifications, drawing, design review, actions taken on review results, and approval. Both the macroscopic work steps and their subdivisions can be monitored by the operation status visualizing system according to the invention. In this case, a hierarchical display method can be used whereby, for example, flows in the subdivided steps can be visualized by selecting the tank 203 shown in FIG. 2 and demanding an instruction for a lower-level display. In this case, the objects of measurement are design drawings or documents, for example, and their numbers or quality are periodically measured.

A second example is where the system is applied to the on-site prorogues-status management in actual factories, for example. In this case the individual work processes include procurement of parts, operations at various machining centers, and quality inspection, for example. The objects of measurement include the number and/or the degree of completion of the parts or products to be worked in each work process.

A third example is where the system of the invention is applied to paperwork such as material purchase procedures or various applications. The material purchase procedures include, for example, sending inquiries, obtainment of quotations, determination of contractors, placement of orders, receipt of goods, and inspection of the goods. The objects of measurement are the ordered items, and their numbers or the status of negotiation concerning the items are measured.

In the above-described examples, the number of the objects of measurement, when they are data in a computer, can be measured by counting the number of files stored in each storage unit 103 using each work tool 101. When the measured objects are actual parts, for example, their numbers can be measured by a dedicated counter provided in each work tool.

Software for realizing the visualizing system as described above can be distributed in the form of memory media and installed on each work tool 101 and the progress-status monitoring tool 104. As the use of the visualizing system facilitates the discovery of manufacturing process bottlenecks, work improvement services can be provided using the inventive system as a tool. For example, the visualizing system of the invention can be introduced into a client's business. By monitoring the flow of work for a particular period of time, pieces of work that are not flowing smoothly or operation with lower throughput can be analyzed. Further, changes in the status of progress of the overall work flow that can be expected if the throughput is improved can be simulated based on past work data monitored in the past.

Thus, in accordance with the present embodiment, the status of overall progress of a project consisting of multiple work processes that are simultaneously carried out in parallel can be displayed. Accordingly, the status of progress of each work process and the results of transfer of data between individual work processes can be intuitively grasped. Further, the embodiment allows the identification of how a specific process is being delayed along the time axis, and whether the task is really being delayed or just standing by. By looking at the display, one can also make predictions about the future work progress based on the past results. Further, by simultaneously displaying chronological graphs of multiple work processes, one can confirm the status of synchronization of the individual work processes.

Thus, the present embodiment, allows information necessary for the efficient execution of tasks to be easily obtained, thus helping to make the process of designing more efficient and contributing to reduced cost.

As described above, the present invention provides the following effects.

According to claim 1, when a task is divided into multiple work processes that are shared, the status of progress of individual work processes and the results of data transfer between individual work processes can be grasped intuitively. It can also be recognized how a work process is being delayed along the time axis. By looking at the graphs, estimates can be made concerning future work progress based on the past results. Furthermore, by displaying chronological graphs of multiple work processes simultaneously the status of synchronization of the multiple work processes can be confirmed.

According to claim 2, when a task is divided into multiple work processes that are shared, the status of progress of individual work processes and the results of data transfer between the individual work processes can be grasped intuitively. Thus, chronological chances in the quality of remaining work can be intuitively grasped.

According to claim 3, when a task is divided into multiple work processes that are shared, the status of progress of individual work processes and the result of data transmission between individual work processes can be intuitively grasped. By displaying the number of days that have passed, the status of work that has been remaining for a long time can be confirmed. By displaying the number of days until a deadline, an item of work or a work process that is likely to be behind schedule can be grasped.

According to claim 4, when a task is divided into multiple work processes that are shared, the status of progress of individual work processes and the result of data transmission between individual work processes can be intuitively rasped. By displaying the ratio of work that has been completed, estimates can be made as to when a piece of work can be passed onto the next work process.

According to claim 5, when a task is divided into multiple work processes that are shared, the status of progress of individual work processes and the result of data transmission between individual work processes pan be intuitively grasped. Further, relative work efficiency of each work process can be grasped from an overall point of view.

According to claim 6, when a task is divided into multiple work processes that are shared, the status of progress of individual work processes and the result of data transmission between individual work processes can be intuitively grasped.

According to claim 7, when a task is divided into multiple work processes that are shared, the status of progress of individual work processes and the result of data transmission between individual work processes can be intuitively grasped. Further, the work processes as they are performed in a flow of work, the flow of work and the control of the flow can be more intuitively grasped by describing them using metaphors of tanks, pipes, and valves that are typically used in piping and instrumentation drawings in the design of piping, for example.

According to claim 8, when a task is divided into multiple work processes that are shared, the status of progress of individual work processes and the result of data transmission between individual work processes can be intuitively grasped. Further, the work processes as they are performed in a flow of work, the flow of work and the control of the flow can be more intuitively grasped by describing them using metaphors of tanks, pipes, and valves that are typically used in piping and instrumentation drawings in the design of piping, for example.

According to claim 9, when a task is divided into multiple work processes that are shared, the status of progress of individual work processes and the result of data transmission between individual work processes can be intuitively grasped.

According to claim 10, when a task is divided into multiple work processes that are shared, the status of progress of individual work processes and the result of data transmission between individual work processes can be intuitively grasped.

According to claim 11, when a task is divided into multiple work processes that are shared, the status of progress of individual work processes and the results of data transfer between individual work processes can be grasped intuitively. It can also be recognized how a work process is being delayed along the time axis. By looking at the graphs, estimates can be made concerning future work progress based on the past results. Furthermore, the status of synchronization of the multiple work processes can be confirmed based on the simultaneous display of chronological graphs for multiple work processes.

According to claim 12, when a task is divided into multiple work processes that are shared, the status of progress of individual work processes and the results of data transfer between the individual work processes can be grasped intuitively. Thus chronological changes in the quality of remaining work can be intuitively grasped.

According to claim 13, when a task is divided into multiple work processes that are shared, the status of progress of individual work processes and the result of data transmission between individual work processes can be intuitively grasped. By displaying the number of days that have passed, the status of work that has been remaining for a long time can be confirmed. By displaying the number of days until a deadline, an item of work or a work process that is likely to be behind schedule can be grasped.

According to claim 14, when a task is divided into multiple work processes that are shared, the status of progress of individual work processes and the result of data transmission between individual work processes can be intuitively grasped. By displaying the ratio of work that has been completed, estimates can be made as to when a piece of work can be passed onto the next work process.

According to claim 15, when a task is divided into multiple work processes that are shared, the status of progress of individual work processes and the result of data transmission between individual work processes can be intuitively grasped. Further, relative work efficiency of each work process can be grasped from an overall point of view.

According to claim 16, when a task is divided into multiple work processes that are shared, the status of progress of individual work processes and the result of data transmission between individual work processes can be intuitively grasped.

According to claim 17, when a task is divided into multiple work processes that are shared, the status of progress of individual work processes and the result of data transmission between individual work processes can be intuitively grasped. Further, the work processes as they are performed in a flow of work, the flow of work and the control of the flow can be more intuitively grasped by describing them using metaphors of tanks, pipes, and valves that are typically used in piping and instrumentation drawings in the design of piping, for example.

According to claim 18, when a task is divided into multiple work processes that are shared, the status of progress of individual work processes and the result of data transmission between individual work processes can be intuitively grasped. Further, the work processes as they are performed in a flow of work, the flow of work, and the control of the flow can be intuitively grasped by describing them using metaphors of tanks, pipes, and valves that are typically used in piping and instrumentation drawings in the design of piping, for example.

According to claim 19, when a task is divided into multiple work processes that are shared, the status of progress of individual work processes and the result of data transmission between individual work processes can be intuitively grasped.

What is claimed is:

1. A system for monitoring the status of activity of a task that is divided into a plurality of work processes that arc shared and carried out in parallel, the system comprising:
a first means for measuring the amount of remaining work in each of the multiple work processes;
a second means for storing the amount of remaining work in each of the work processes that is measured by the first means, together with the time of measurement; and
a third means for displaying the amounts of remaining work measured for the individual work processes by way of chronological graphs separately or simultaneously.

2 The work process status controlling system according to claim 1, further comprising:
a fourth means for measuring the quality of each item of remaining work of which the amount has been measured by the second means for each work process; and
a fifth means for displaying the quality of each item of remaining work measured by the fourth means for each work process in the graphs of the amount of remaining work measured for each work process that are displayed by the third means.

3. The work-process status monitoring system according to claim 2, wherein the quality of each item of remaining work measured by the fourth means for each work process is either the number of days that has passed since a particular item of work was registered in a relevant work process or the number of days until the deadline of the relevant work process, wherein the manner of display is varied depending on the number of days.

4. The work-process status monitoring system according to claim 2, wherein the quality of each item of remaining work measured by the fourth means for each work process is the ratio of completion of a relevant work process, wherein the manner of display is varied depending on the ratio of completion.

5. A system for monitoring the status of activity of a task that is divided into a plurality of work processes that are shared and carried out in parallel, the system comprising:
a fifth means for measuring the amounts of transition of work between the individual work processes;
a sixth means for storing the amounts of transition of work between individual word processes measured by the fifth means together with the time of measurement; and
a seventh means for simultaneously displaying the amounts of transition of work between individual work processes, which are stored by the sixth means for each of the multiple work processes, in chronological graphs.

6. A system for monitoring the status of activity of a task that is divided into a plurality of work processes that are shared and carried out in parallel, the system comprising:
a fifth means for measuring the amount of transition of work between the individual work processes;
a sixth means for storing the amount of transition of work between the individual work processes measured by the fifth means, together with the time of measurement; and
an eighth means for simultaneously displaying the accumulation of the transition amount of work between the individual work processes, which are stored by the fifth means for each work process, in chronological graphs.

7. The work process status controlling system according to claim 1, further comprising a ninth means for displaying each work process with a box-shaped icon, the connection of one work process to another with an arrow-shaped icon, and a valve-shaped icon in the middle of the arrow-shaped icon, wherein a graph of remaining work amounts is displayed upon selection of the box-shaped icon. and another graph of the amounts of transition of work between individual work processes is displayed upon selection of the valve-shaped icon.

8. The work-process status monitoring system according to claim 7, wherein the manner in which the valve-shaped icon, which is disposed in the middle of the arrow-shaped icon indicated on the ninth means, is displayed is varied depending on the content of work that is passed from one box-shaped icon to another via the valve-shaped icon if the content of work matches a preset work monitoring content, whereas a warning message is issued if the content of work does not match a preset work monitoring content.

9. The work-process status monitoring system according to claim 8, wherein the preset content of work that is controlled is the deadline or quality of a task.

10. A recording medium in which a software program is stored for analyzing a task using the work-process status monitoring system according to claim 1.

11. A display apparatus for monitoring the status of activity of a task that is divided into a plurality of work processes that are shared and carried out in parallel, the apparatus comprising:
means for measuring the amount of remaining work in each of the multiple work processes;
means for storing the amount of remaining work in each of the work processes that is measured by the remaining amount measuring means, together with the time of measurement; and
means for displaying the amounts of remaining work measured for the individual work processes by way of chronological graphs separately or simultaneously.

12. The work-process status monitoring and display apparatus according to claim 11, further comprising:
means for measuring the quality of each item of remaining work of which the amount has been measured by the work-work amount measuring means for each work process; and
means for displaying the quality of each item of remaining work measured by the remaining-work quality measuring means for each work process, in the graphs of the amount of remaining work measured for each work process that are displayed by the remaining-work amount display means.

13. The work-process status monitoring and display apparatus according to claim 12, wherein the quality of each item of remaining work measured by the remaining-work quality measuring means for each work process is either the number of days that have passed since a particular item of work was registered in a relevant work process, or the number of days until the deadline of a relevant work process, wherein the manner of display is varied depending on the number of days.

14. The work-process status monitoring and display apparatus according to claim 12, wherein the quality of each item of remaining work measured by the remaining-work quality measuring means for each work process is the ratio of completion of a relevant work process, wherein the manner of display is varied depending on the ratio of completion.

15. A display apparatus for monitoring the status of activity of a task that is divided into a plurality of work processes that are shared and carried out in parallel, the apparatus comprising:
means for measuring the amount of transition of work between the individual work processes;
means for storing the amount of transition of work between the individual work processes measured by the transitioned work amount measuring means, together with the time of measurement; and
means for simultaneously displaying the amounts of transition of work between individual work processes, which are measured by the transitioned work amount measuring means for each of the multiple work processes, in chronological graphs.

16. A display apparatus for monitoring the status of activity of a task that is divided into a plurality of work processes that are shared and carried out in parallel, the apparatus comprising:
means for measuring the amount of transition of work between the individual work processes;
means for storing the amount of transition of work between the individual work processes measured by the transitioned work amount measuring means, together with the time of measurement; and
means for simultaneously displaying the accumulation of the transition amount of work between the individual work processes, which are measured by the transitioned work amount measuring means for each work process, in chronological graphs.

17. The work-process status monitoring and display apparatus according to claim 11, comprising a display means for displaying each work process with a box shaped icon the connection of one work process to another with an arrow-shaped icon, and a valve-shaped icon in the middle of the arrow-shaped icon, wherein a graph of remaining work amounts is displayed upon selection of the box-shaped icon, and another graph of the amounts of transition of work between individual work processes is displayed upon selection of the valve-shaped icon.

18. The work-process status monitoring and display apparatus according to claim 17, wherein the manner in which the valve-shaped icon, which is disposed in the middle of the arrow-shaped icon on the display means, is displayed is varied depending on the content of work that is passed from one box-shaped icon to another via the valve-shaped icon if the content of work matches a preset work monitoring content, whereas a warning message is issued if the content of work does not match a preset work monitoring content.

19. The work-process status monitoring and display apparatus according to claim 18, wherein the preset content of work that is monitored is the deadline or quality of a task.
